(19) United States
(12) Patent Application Publication
(10) Pub. No.: US 2006/0208451 A1
(43) Pub. Date: Sep. 21, 2006

(54) Drive Unit for a Bicycle

(76) Inventor: Johannes Buchner, Hallein (AT)

Correspondence Address: GUDRUN E. HUCKETT DRAUDT, LONSSTR. 53, WUPPERTAL, 42289, DE

(21) Appl. No.: 11/306,390

(22) Filed: Dec. 27, 2005

(30) Foreign Application Priority Data
Jan. 26, 2005 (AT) A115/2005

(51) Int. Cl. B62M 9/04

(52) U.S. Cl. 280/210

(57) ABSTRACT

A retrofittable drive unit for bicycles has an electric power source and an electric motor connected to the electric power source. A drive wheel is attached to spokes of the rear wheel of the bicycle. A tractive device transmits torque generated by the electric motor onto the drive wheel. The drive unit is connected to the bicycle frame of the bicycle near the axle of the rear wheel on a side of the rear wheel opposite the chain of the bicycle and laterally adjacent to the rear wheel.

### BACKGROUND OF THE INVENTION

The invention relates to a retrofittable drive unit for bicycles that is comprised of an electric power source and an electric motor.

It is generally known that there are many different types of bicycles such as lady's bicycles, man's bicycles, racing bicycles, touring bicycles, street or city bicycles, and mountain bicycles (mountain bikes). In addition, bicycles are provided with different types of gear systems and brake devices; some are equipped with fenders or mud guards, pannier racks, or rear wheel suspension systems.

A disadvantage of prior art drive units is that they can be mounted only on a fraction of the bicycles on the market. Another disadvantage is that a bicycle that can be retrofitted with a prior art drive unit usually must be converted or even machined and, moreover, mounting is laborious and difficult. Also, prior art drive units are complex and complicated, are impractical when riding the bicycle and expensive to manufacture.

An example of such a drive unit is disclosed in patent application WO 93/11992. This drive unit is attached above the rear axle to the right on the bicycle frame. This drive unit transmits force by means of a chain onto a separate chain ring or sprocket that is to be mounted next to the already present chain sprockets. In the case of bicycles without gear system or with an internal gear hub, mounting of a separate chain sprocket is practically impossible. Moreover, the attachment of this drive unit leads to a bulky configuration and the drive unit extends into an area where on many bicycles brake parts or the dynamo or generator is located. Moreover, arranging such a drive at this location leads to deterioration of the riding behavior because the center of gravity is unfavorably high.

Drive units with a friction roll drive action are also known; they exhibit the same problems as described above. In addition, they also have the disadvantage of an unsatisfactory power transmission. Therefore, it is not surprising that the prior art drive units designed for retrofitting on bicycles have not succeeded in the market place.

### SUMMARY OF THE INVENTION

It is an object of the present invention to provide a retrofittable drive unit with electric power source and electric motor that can be easily and without problems mounted on all popular bicycles. Also, the drive unit should not be an impairment when riding the bicycle; the center of gravity of the bicycle provided with the drive unit should be very low in order to provide excellent riding behavior and in order to be able be park the bicycle easily. In addition, the drive unit also should ensure excellent power transmission and should have a minimal weight.

In accordance with the present invention, this is achieved in that the drive unit is mountable in the area of the axle of the rear wheel on the side opposite the chain laterally adjacent to the rear wheel on the bicycle frame and in that the electric motor transmits its torque by means of a tractive device onto a drive wheel that is attached to the spokes of the rear wheel.

According to the present invention, the drive unit is mounted in the area of the axle of the rear wheel on the side of the rear wheel opposite to the chain adjacent to the rear wheel on the bicycle frame. The biggest advantage of this arrangement the drive unit is that bicycles of may different configurations and provided with different equipment are usually identically configured at this location so that at this location mounting on all popular bicycles is possible in the same way.

An additional advantage resides in that a very simple drive transmission onto the rear wheel is enabled at this location. For this purpose, a drive wheel is attached to the spokes of the rear wheel. Torque transmission from the drive pinion of the motor is realized by means of the tractive device onto the drive wheel. By attaching the drive wheel on the spokes, the drive wheel can be mounted also on wheels with different hubs or gear systems. Advantageously, a drive wheel is used as disclosed in Austrian patent application A 2005/114; the tractive device is preferably a toothed drive belt in order to enable a slip-free and maintenance-free drive transmission.

Advantageously, an auxiliary bracket is used as a supporting component of the drive unit. The bracket can be manufactured from a substantially straight round metal pipe. Holders for the drive motor and the electric power source can be mounted on this bracket. Also, this bracket can be attached very simply and advantageously by means of only two clamps on the bicycle frame. Advantageously, the front end of the bracket (relative to the bicycle traveling direction) is secured by means of a clamp on the chain stay and at a second location clamping of the clamp can be realized by means of the axle bolt and the axle nut so that at this location there is not even a screw required. With regards to load considerations, it is very beneficial to attach the holders for the electrical power source in the area of front end of the auxiliary bracket. On the other hand, the motor should be father removed from the axle near the rear end of the auxiliary bracket so that the tractive device surrounds the drive pinion of the motor properly. Also, an additional holder for an electric motor control can be attached to the auxiliary bracket.

The above description demonstrates that the drive unit according to the invention has many advantages. It can be mounted on all popular and differently designed bicycles in a very simple way; it is essentially service-friendly because all parts are easily accessible; it can be produced inexpensively; and the center of gravity of the bicycle provided with the drive unit according to the invention is very low.

### BRIEF DESCRIPTION OF THE DRAWING

FIG. 1 is a side view of the drive unit mounted on a bicycle.

FIG. 2 is a view of the front attachment of the auxiliary bracket according to arrow II of FIG. 1.

FIG. 3 shows a clamp for the attachment of the auxiliary bracket on the wheel axle.

FIG. 4 illustrates a holder for the battery.

FIG. 5 shows the holder for the motor control.

FIG. 6 shows the holder for the drive motor.

### DESCRIPTION OF THE PREFERRED EMBODIMENTS

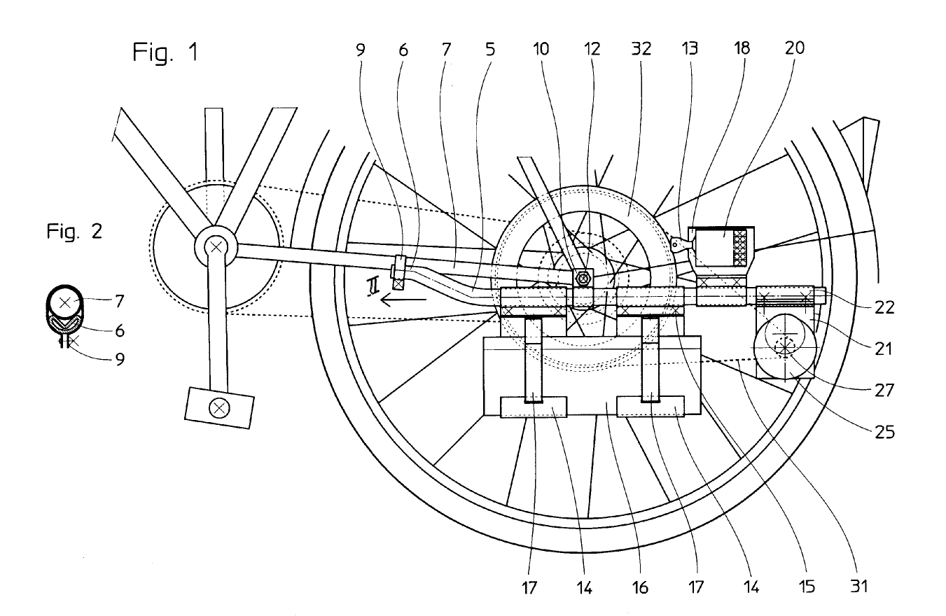

The drive unit illustrated in FIG. 1 is mounted in the area of the axle (at 12) of the rear wheel on the side of the rear wheel opposite the chain laterally adjacent to the rear wheel on the bicycle frame.

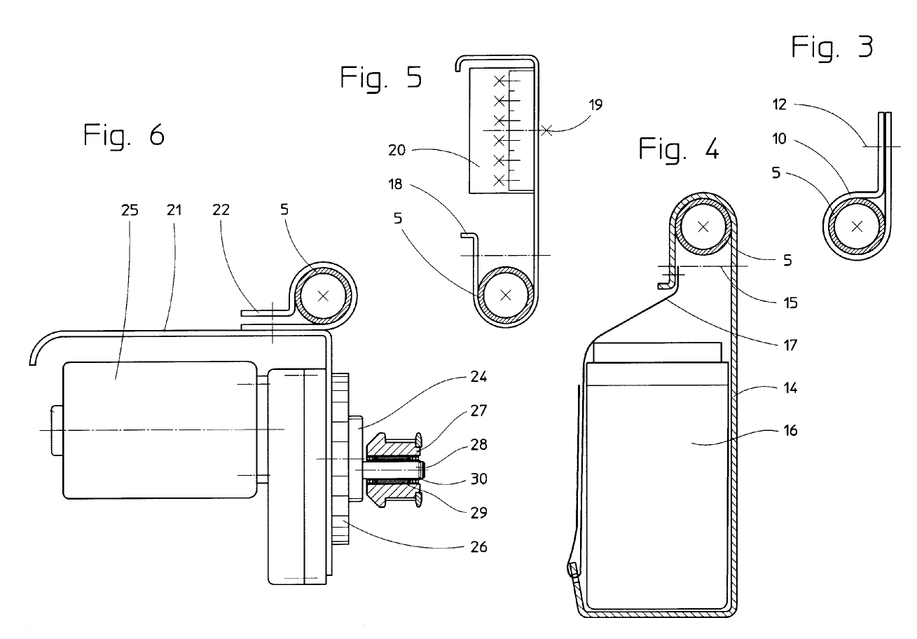

A supporting component of the drive unit is the auxiliary bracket 5. The auxiliary bracket 5 is made from an elongate metal pipe and its front end is slightly curved or bent. The front end 6 of the auxiliary bracket 5 is flattened from the round shape to a V-shape so that it rests positively on the chain stay 7 of the bicycle frame (see FIG. 2). The end 6 is clamped onto the chain stay 7 by means of clamp 9 and a screw. A second clamp 10 (FIG. 3) clamps the auxiliary bracket 5 onto the axle bolt 12 of the rear wheel; the axle bolt is secured by means of an axle nut. The auxiliary bracket 5 is attached to the (left) side of the bicycle opposite the chain because at this side there is no gear system that could be an obstacle.

On the auxiliary bracket 5 the holder for the battery 16, the drive motor 25, and the motor control 20 are attached. According to FIG. 4, on the auxiliary bracket 5 two L-shaped holders 14 for the battery 16 are attached. One of the holders is positioned in front of and the other behind the axle (12) of the rear wheel (viewed in the traveling direction). They are secured like clamps by means of their curved and semi-circular upper ends on the auxiliary bracket 5 by means of screws 15. The rectangular and elongate battery 16 is inserted into the two holders 14 and secured therein by means of two hook-and-loop fasteners 17. Instead of the battery 16 it is also possible in the future to use a fuel cell. According to FIG. 5, in the same way as the holder 14, but upside down, the holder 18 for the motor control 20 is attached to the auxiliary bracket 5. The motor control 20 is secured on the holder by means of screw 19. The motor control 20 is connected by cables, not illustrated, to the battery 16, the drive motor 25, and a throttle control or rotary throttle handle (not illustrated). The motor control 20 is advantageously provided with a key switch 13 (FIG. 1) for turning on and off the drive unit.

According to FIG. 6, on the rear end of the auxiliary bracket 5 the angular motor holder 21 is clamped by means of a wide securing clamp 22. The bores for the clamping screws in the motor holder 21 are elongate (slotted) in order to be able to align it properly so that the belt 31 (FIG. 1) can run straight. The drive motor 25 is inserted with an eccentric threaded pin 24 through a matching bore of the motor holder 21 and is tightened by a knurled nut 26. By rotating the drive motor 25 in the motor holder 21, the toothed belt 31 can be tensioned or loosened. Between the drive pinion 27 and the drive shaft 28 of the drive motor 25 bearings are provided and between them a free wheel 29 is mounted. When the motor 25 is driven, the freewheel 29 transmits the rotation of the drive shaft 28 onto the drive pinion 27. When the drive motor provides no drive action, the drive pinion 27 rotates on the stopped drive shaft 28. By means of the spring ring 38 the drive pinion 27 is axially secured on the shaft 28. In this way, the drive, depending on the individual preferences of the user, can be realized by physical power or by electric drive action; when the motor drive is turned off, no additional resistance can be sensed.

According to FIG. 1, the drive pinion 27 transmits its rotation by means of the toothed belt 31 onto the drive wheel 32 that is attached to the spokes of the rear wheel. Such a drive wheel 32 is disclosed in detail in Austrian patent application A 2005/114.

While specific embodiments of the invention have been shown and described in detail to illustrate the inventive principles, it will be understood that the invention may be embodied otherwise without departing from such principles.

What is claimed is:

1. A retrofittable drive unit for bicycles, the drive unit comprising:
an electric power source;
an electric motor connected to said electric power source;
a drive wheel adapted to attach to spokes of a rear wheel of a bicycle;
a tractive device transmitting a torque generated by said electric motor onto said drive wheel;
wherein said drive unit is adapted to connect to a bicycle frame of the bicycle near an axle of the rear wheel on a side of the rear wheel opposite a chain of the bicycle and laterally adjacent to the rear wheel.

2. The retrofittable drive unit according to claim 1, wherein said electrical power source is arranged in a travel direction of the bicycle in front of said electric motor.

3. The retrofittable drive unit according to claim 1, wherein said tractive device is a tooth belt.

4. The retrofittable drive unit according to claim 1, further comprising an auxiliary bracket adapted to be mounted on the bicycle by an axle bolt of the bicycle and onto at least one frame part of the bicycle frame.

5. The retrofittable drive unit according to claim 4, further comprising holders for said electric power source and said electric motor which holders are attached to said auxiliary bracket.

6. A retrofittable drive unit according to claim 4, wherein said auxiliary bracket is comprised of a metal pipe.

7. A retrofittable drive unit according to claim 4, further comprising an electronic motor control connected to said electric motor and a holder for said electronic motor control, wherein said holder is attached to said auxiliary bracket.
